(19) United States
(12) Patent Application Publication
(10) Pub. No.: US 2020/0262413 A1
(43) Pub. Date: Aug. 20, 2020

(54) METHOD AND SYSTEM FOR REGENERATING ELECTRICAL ENERGY IN A HYBRID VEHICLE

(71) Applicant: BorgWarner Inc., Auburn Hills, MI (US)

(72) Inventors: B. Jerry Song, Novi, MI (US); Keith Van Maanen, Bloomfield Hills, MI (US); Sara Mohon, Auburn Hills, MI (US); Wen Gao, Mainz (DE)

(21) Appl. No.: 16/278,365

(22) Filed: Feb. 18, 2019

(51) Int. Cl. B60W 20/14; B60K 6/40; B60K 6/387; B60W 10/08; B60W 10/06; B60W 10/26; B60W 30/18; F02B 37/04; F02B 39/10; F02B 37/18

(52) U.S. Cl. CPC B60W 20/14; B60K 6/40; B60K 6/387; B60W 10/08; B60W 10/06; B60W 10/26; B60K 6/24; B60W 30/18136; F02B 37/04; F02B 39/10; F02B 37/18; B60W 2510/244; B60W 30/18127

(57) ABSTRACT

A system includes an internal combustion engine including a crankshaft, a transmission including a transmission shaft, an axle, and a first electric machine rotatably coupled at least one of the crankshaft, the transmission shaft, and the axle. The first electric machine is configured to deliver rotational torque, and to generate electrical energy. The system includes an electrically-assisted turbomachine including a second electric machine configured to deliver rotational torque, and to generate electrical energy. The system includes a hybrid propulsion traction battery electrically coupled to the first and second electric machines. The hybrid propulsion traction battery is configured to deliver electrical energy to the first electric machine, and to receive electrical energy from the first and second electric machines. The system includes an electronic control unit configured to control electrical energy supplied to the first electric machine, and to control electrical energy supplied to the hybrid propulsion traction battery.

### BACKGROUND OF THE INVENTION

1. Field of the Invention

The present invention generally relates to a method and a system for regenerating electrical energy in a hybrid vehicle.

2. Description of the Related Art

Conventional hybrid vehicles in the art typically include a system for regenerating electrical energy and for using the electrical energy for driving the hybrid vehicle. Typical systems in hybrid vehicles include an internal combustion engine including a crankshaft, a transmission including a transmission shaft rotatably coupled to the crankshaft, and an axle rotatably coupled to the transmission shaft. Typical systems may additionally include an electric machine rotatably coupled to one of the crankshaft, the transmission shaft, and the axle for providing additional rotational torque to one of the crankshaft, the transmission shaft, and the axle. The system also includes a hybrid propulsion traction battery electrically coupled to the electric machine for providing electrical power to the electric machine to provide additional rotational torque to one of the crankshaft, the transmission shaft, and the axle. The system additionally includes an electronic control unit to control electrical energy supplied to the first electric machine from the hybrid propulsion traction battery, and to control electrical energy supplied to the hybrid propulsion traction battery from the first electric machine.

During operation of the hybrid vehicle, conventional systems use various control strategies to take advantage of energy storage to minimize the overall fuel consumption during operation. For example, when a power demand to drive the hybrid vehicle increases, electrical energy is supplied to the electric machine to assist the internal combustion engine in driving the hybrid vehicle. When power demand of the hybrid vehicle decreases, electrical energy is supplied to the hybrid propulsion traction battery from the electric machine to charge the hybrid propulsion traction battery. When power demand to drive the hybrid vehicle is low, for example at speeds below 10 miles per hour, the electric machine may drive the hybrid vehicle in an electric-only drive mode. However, such control strategies of conventional systems do not optimally control when electrical energy should be supplied to and from the hybrid propulsion traction battery and the electric machine, which results in increased fuel consumption and a less efficient hybrid vehicle.

As such, there remains a need to provide an improved system for regenerating electrical energy and for using the electrical energy to drive the hybrid vehicle. Additionally, there remains a need for a method for regenerating electrical energy and for using the electrical energy to drive the hybrid vehicle.

### SUMMARY OF THE INVENTION AND ADVANTAGES

A system for regenerating electrical energy and for using the electrical energy for driving a hybrid vehicle includes an internal combustion engine including a crankshaft. The system also includes a transmission including a transmission shaft rotatably coupled to the crankshaft, and an axle rotatably coupled to the transmission shaft. The system additionally includes a first electric machine rotatably coupled at least one of the crankshaft, the transmission shaft, and the axle. The first electric machine is configured to deliver rotational torque to at least one of the crankshaft, the transmission shaft, and the axle, and to generate electrical energy from rotation of at least one of the crankshaft, the transmission shaft, and the axle. The system further includes an electrically-assisted turbomachine including a shaft and a second electric machine configured to deliver rotational torque to the shaft and to generate electrical energy from rotation of the shaft. The system also includes a hybrid propulsion traction battery electrically coupled to the first and second electric machines. The hybrid propulsion traction battery is configured to deliver electrical energy to the first electric machine, and to receive electrical energy from the first and second electric machines for charging the hybrid propulsion traction battery. The system additionally includes an electronic control unit configured to control electrical energy supplied to the first electric machine from the hybrid propulsion traction battery, and to control electrical energy supplied to the hybrid propulsion traction battery from the first and second electric machines.

A method for regenerating electrical energy and for using electrical energy for driving a hybrid vehicle is also described herein. The method includes the steps of determining an electric-brake specific fuel consumption (eBSFC) value, comparing the eBSFC value and a threshold eBSFC value, and charging the hybrid propulsion traction battery with at least one of the first and second electric machines when the eBSFC value is less than the threshold eBSFC value.

Accordingly, the system including the first electric machine, the second electric machine, and the electronic control unit, with the electronic control unit configured to control electrical energy supplied to the first electric machine from the hybrid propulsion traction battery, and to control electrical energy supplied to the hybrid propulsion traction battery from the first and second electric machines optimizes fuel consumption and results in a more efficient hybrid vehicle.

Additionally, the method including the steps of determining an electric-brake specific fuel consumption (eBSFC) value, comparing the eBSFC value and a threshold eBSFC value, and charging the hybrid propulsion traction battery with at least one of the first and second electric machines when the eBSFC value is less than the threshold eBSFC value optimizes fuel consumption and results in a more efficient hybrid vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a system of a hybrid vehicle, with the system including an internal combustion engine including a crankshaft, a transmission including a transmission shaft, an axle, a first electric machine, an electrically-assisted turbomachine including a second electric machine, a hybrid propulsion traction battery, and an electronic control unit, and with the first electric machine being rotatably coupled to the crankshaft;

FIG. 2 is a schematic view of the system, with the first electric machine being rotatably coupled to the crankshaft;

FIG. 3 is a schematic view of the system, with the system further including a disconnect clutch rotatably coupling the transmission shaft with the crankshaft, and with the first electric machine being directly rotatably coupled to the transmission shaft;

FIG. 4 is a schematic view of the system, with the first electric machine being rotatably coupled to the transmission shaft;

FIG. 5 is a schematic view of the system, with the first electric machine being directly rotatably coupled to an output of the transmission shaft;

FIG. 6 is a schematic view of the system, with the first electric machine being rotatably coupled to the axle;

FIG. 7 is a schematic view of an electrically-assisted turbocharger including the second electric machine;

FIG. 8 is a graph representing six different operating conditions of the internal combustion engine;

FIG. 9 is a graph representing an electric brake-specific fuel consumption (eBSFC) associated with the use of the first and second electric machines and a brake-specific fuel consumption (BSFC) of the internal combustion engine at each of the six operating conditions of FIG. 8;

FIG. 10 is a graph representing a first, second, third, and fourth region of operation of the hybrid vehicle, with the first region representing operating conditions where the first electric machine may charge the hybrid propulsion traction battery, with the second region representing operating conditions where the second electric machine may charge the hybrid propulsion traction battery, with the third region representing operating conditions where the first electric machine may be used to drive the hybrid vehicle without the use of the internal combustion engine, and with the fourth region representing a typical operating range of the internal combustion engine overlapping with the first, second, and third regions;

FIG. 11 is a graph representing a fifth region of operation of the hybrid vehicle, with the fifth region representing operating conditions where the first and second electric machines may be used to charge the hybrid propulsion traction battery;

FIG. 12 is a graph representing eBSFC values associated with the use of the first electric machine based on a brake mean effective pressure (BMEP) and rotations per minute (RPM) of the internal combustion engine;

FIG. 13 is a graph representing eBSFC values associated with the use of the second electric machine based on the BMEP and RPM of the internal combustion engine;

FIG. 14 is a graph representing values of electrical power generated from the second electrical machine on the BMEP and RPM of the internal combustion engine;

FIG. 15 is a flow chart of a method for regenerating electrical energy and for using the electrical energy for driving a hybrid vehicle, with the method including the steps of determining an electric-brake specific fuel consumption (eBSFC) value, comparing the eBSFC value and a threshold eBSFC value, and charging the hybrid propulsion traction battery with at least one of the first and second electric machines when the eBSFC value is less than the threshold eBSFC value;

FIG. 16 is a flow chart of the method of FIG. 15, further including the steps of determining a state of charge of the hybrid propulsion traction battery, comparing the state of charge of the hybrid propulsion traction battery and a threshold state of charge of the hybrid propulsion traction battery, and charging the hybrid propulsion traction battery with at least one of the first and second electric machines when the state of charge of the hybrid propulsion traction battery is less than the threshold state of charge of the hybrid propulsion traction battery;

FIG. 17 is a flow chart of the method of FIG. 16, with the step of charging the hybrid propulsion traction battery with at least one of the first and second electric machines when the eBSFC value is less than the threshold eBSFC value is further defined as charging the hybrid propulsion traction battery with both of the first and second electric machines when the eBSFC value associated with the use of both of the first and second electric machines is less than the threshold eBSFC value;

FIG. 18 is a flow chart of the method of FIG. 15, further including the step of delivering torque from the first electric machine to at least one of the crankshaft, the transmission shaft, and the axle when the eBSFC value associated with the use of the first electric machine is less than the threshold eBSFC value;

FIG. 19 is a flow chart of another embodiment of the method of FIG. 15;

FIG. 20A is an enlarged graph from FIG. 19 showing an electric drive threshold value based on the state of charge of the hybrid propulsion traction battery and the BSFC of the internal combustion engine;

FIG. 20B is an enlarged graph from FIG. 19 showing an eBSFC generate threshold based on the state of charge of the hybrid propulsion traction battery and the eBSFC for a charging condition of the first and/or second electric machines; and

FIG. 21 is a flow chart of another embodiment of the method of FIG. 15.

### DETAILED DESCRIPTION OF THE INVENTION

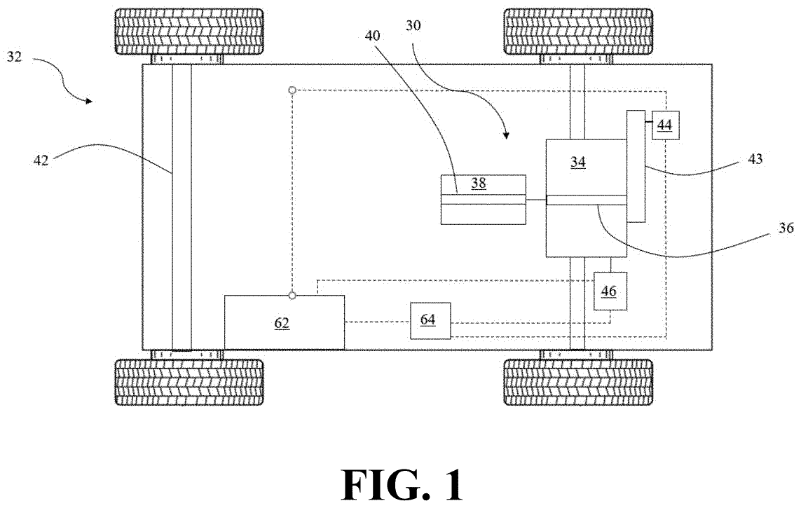

With reference to the Figures, wherein like numerals indicate like parts throughout the several views, a system 30 is schematically shown in FIGS. 1-6. The system 30 regenerates electrical energy and uses the electrical energy for driving a hybrid vehicle 32. It is to be appreciated that the schematic view the hybrid vehicle 32 in FIGS. 1-6 may be a front wheel drive vehicle, a rear wheel drive vehicle, or an all-wheel drive vehicle. The system 30 includes an internal combustion engine 34 including a crankshaft 36, a transmission 38 including a transmission shaft 40 rotatably coupled to the crankshaft 36, and an axle 42 rotatably coupled to the transmission shaft 40. In some embodiments, the system 30 includes a driveshaft rotatably coupled to the transmission shaft 40 and the axle 42. In some embodiments, the axle 42 is a front axle. In some embodiments, the axle 42 is a rear axle.

The system 30 also includes a first electric machine 44 rotatably coupled to at least one of the crankshaft 36, the transmission shaft 40, and the axle 42. The first electric machine 44 is configured to deliver rotational torque to at least one of the crankshaft 36, the transmission shaft 40, and the axle 42, and to generate electrical energy from rotation of at least one of the crankshaft 36, the transmission shaft 40, and the axle 42.

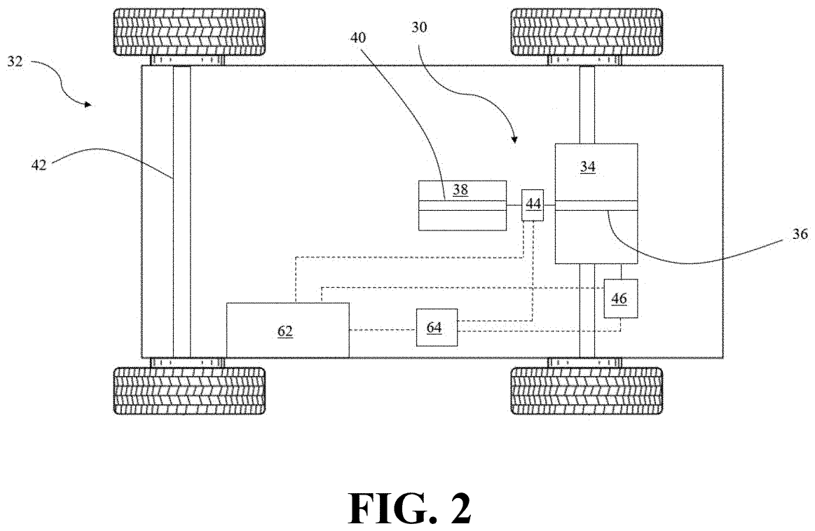

In one embodiment, as shown in FIGS. 1 and 2, the first electric machine 44 is rotatably coupled to the crankshaft 36 such that the first electric machine 44 is configured to deliver rotational torque to the crankshaft 36 and to generate electrical energy from rotation of the crankshaft 36.

With particular reference to FIG. 1, the first electric machine 44 may be rotatably coupled to the crankshaft 36 through a drive portion 43. The drive portion 43 is commonly referred to as a front end accessory drive (FEAD), such as a belt drive or a chain drive. In such embodiments, the first electric machine 44 is configured to deliver rotational torque to the crankshaft 36 through the drive portion 43, and the first electric machine 44 is configured to generate electrical energy from rotation of the crankshaft 36, which is transmitted through the drive portion 43 to the first electric machine 44. In such embodiments where the first electric machine 44 is rotatably coupled to the crankshaft 36 through the drive portion 43, the first electric machine 44 is commonly referred to as a PO hybrid module or a Belt Alternator Starter (BAS Hybrid).

With particular reference to FIG. 2, the first electric machine 44 may be directly coupled to the crankshaft 36. When the first electric machine 44 is directly coupled to the crankshaft 36, the first electric machine 44 is configured to deliver rotational torque directly to the crankshaft 36 and to generate electrical energy from rotation of the crankshaft 36. Additionally, when the first electric machine 44 is directly coupled to the crankshaft 36, the first electric machine 44 is commonly referred to as a P1 hybrid module.

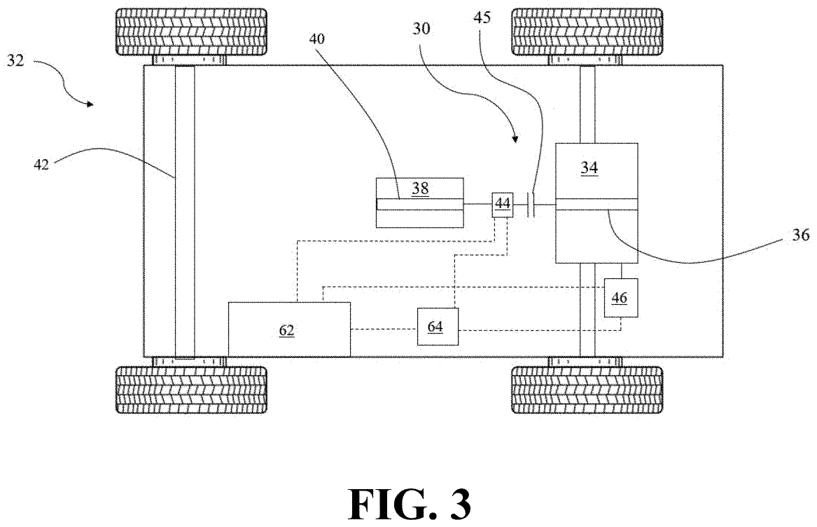

In one embodiment, as shown in FIGS. 3-5, the first electric machine 44 is rotatably coupled to the transmission shaft 40 such that the first electric machine 44 is configured to deliver rotational torque to the transmission shaft 40 and to generate electrical energy from rotation of the crankshaft 36.

With particular reference to FIG. 3, the first electric machine 44 may be selectively rotatably coupled to the crankshaft 36 through a disconnect clutch 45 that selectively rotatably couples the crankshaft 36 and the transmission shaft 40. In embodiments where the first electric machine 44 is rotatably coupled to the transmission shaft 40 and is selectively rotatably coupled to the crankshaft 36 through the disconnect clutch 45, the first electric machine 44 is commonly referred to as a P2 hybrid module. In such embodiments, the first electric machine 44 is configured to deliver rotational torque to the transmission shaft 40 when the first electric machine 44 is both rotatably coupled and decoupled to the crankshaft 36 through the disconnect clutch 45. Typically, the first electric machine 44 is directly rotatably coupled to an input of the transmission shaft 40. When the disconnect clutch 45 is disengaged such that the first electric machine 44 and, in turn, the transmission shaft 40 is rotationally decoupled from the crankshaft 36, the first electric machine 44 may provide rotational torque to the transmission shaft 40 independent from the crankshaft 36, and may generate electrical energy from rotation of the transmission shaft 40. When providing rotational torque to the transmission shaft 40 when the disconnect clutch 45 is disengaged, the first electric machine 44 is able to drive the hybrid vehicle 32 without any rotational torque delivered from the internal combustion engine 34 through the crankshaft 36. Such situations may be referred to as an electric only mode of the hybrid vehicle 32. Alternatively, when the disconnect clutch 45 is engaged such that the transmission shaft 40 and crankshaft 36 are rotatably coupled to one another, the first electric machine 44 may also deliver rotational torque to the transmission shaft 40 to assist the internal combustion engine 34 in driving the hybrid vehicle 32. When generating electrical energy from rotation of the transmission shaft 40 with the first electric machine 44 when the disconnect clutch 45 is disengaged, the first electric machine 44 is typically used for regenerative braking. In such instances, the first electric machine 44 may be configured to rotate at higher rotational speeds than when directly coupled to the crankshaft 36, as the first electric machine 44 can convert rotation from the transmission shaft 40 into electrical energy. This allows a higher amount of electrical energy to be generated from the first electric machine 44.

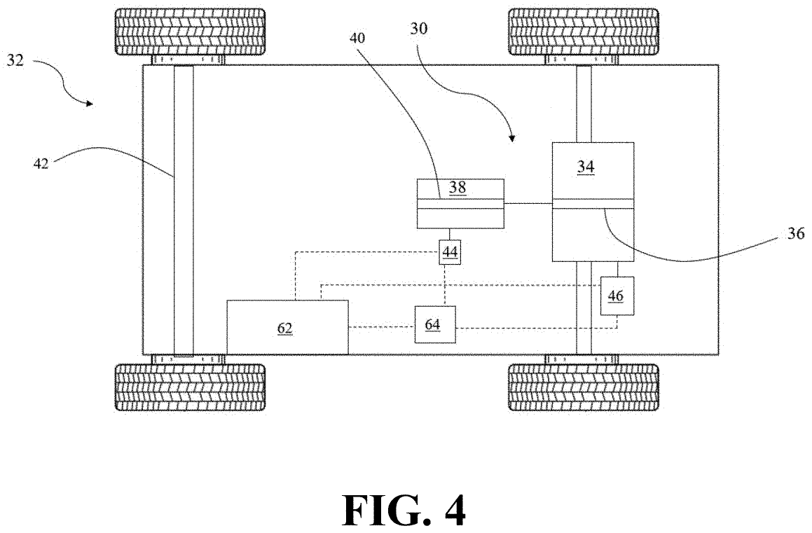

With particular reference to FIG. 4, the first electric machine 44 is rotatably coupled to the transmission shaft 40 such that the first electric machine 44 is configured to deliver rotational torque to the transmission shaft 40 and to generate electrical energy from rotation of the transmission shaft 40. When the first electric machine 44 is rotatably coupled to the transmission shaft 40 such that the first electric machine 44 is configured to deliver rotational torque to the transmission shaft 40 and to generate electrical energy from rotation of the transmission shaft 40, the first electric machine 44 is commonly referred to as a PS (power split) hybrid module. In such embodiments with a PS hybrid module, the PS hybrid module includes two electric machines, both of which are typically disposed in the transmission 38.

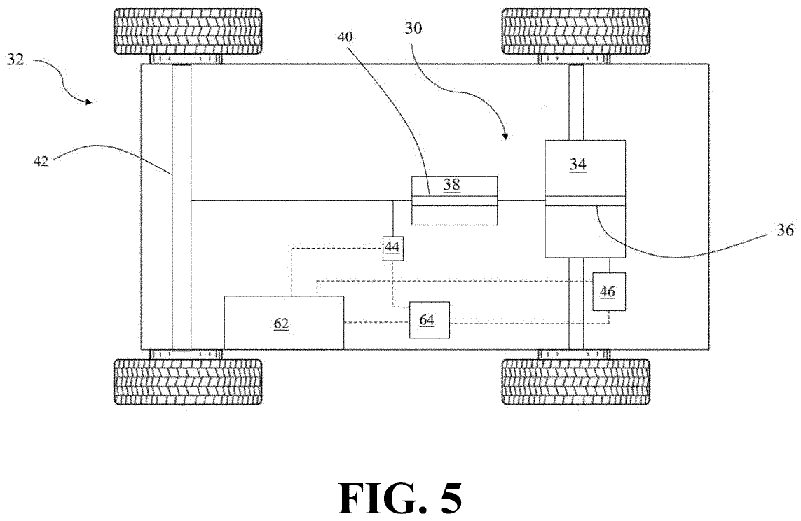

With particular reference to FIG. 5, the first electric machine 44 is directly rotatably coupled to the transmission shaft 40. Typically, the first electric machine 44 is directly rotatably coupled to an output of the transmission shaft 40. In such embodiments, the first electric machine 44 is configured to deliver rotational torque to the output of the transmission shaft 40 and to generate electrical energy from rotation of the output of the transmission shaft 40. When the first electric machine 44 is directly rotatably coupled to the output of the transmission shaft 40, the first electric machine is commonly referred to as a P3 hybrid module.

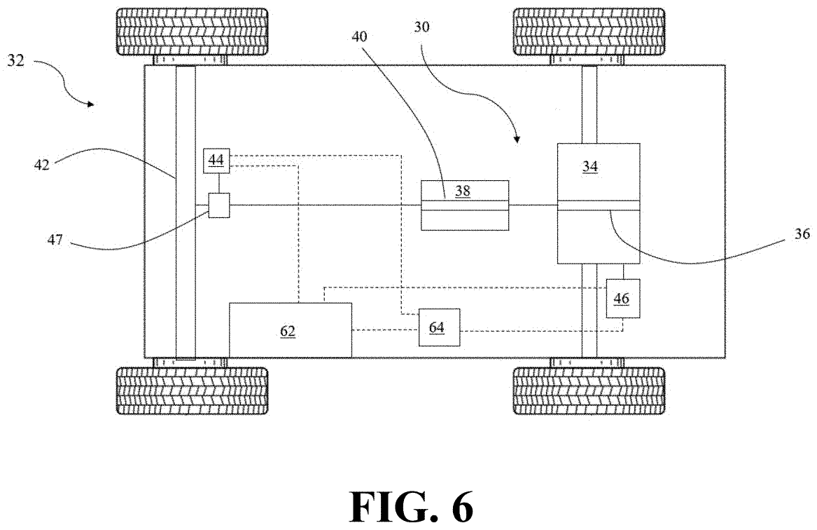

In one embodiment, as shown in FIG. 6, the first electric machine 44 is rotatably coupled to the axle 42 such that the first electric machine 44 is configured to deliver rotational torque to the axle 42 and to generate electrical energy from rotation of the axle 42. In such embodiments, the first electric machine 44 is commonly referred to as a P4 hybrid module. Typically, in such embodiments, the first electric machine 44 is rotatably coupled to the axle 42 through a gear mesh 47, such as a rear differential. The first electric machine 44 may also be directly rotatably coupled to the axle 42. When the first electric machine 44 is rotatably coupled to the axle 42, the internal combustion engine 34 may be configured to drive the front axle and the first electric machine 44 may be configured to drive the rear axle. Such embodiments allow the hybrid vehicle 32 to selectively be an all-wheel drive vehicle.

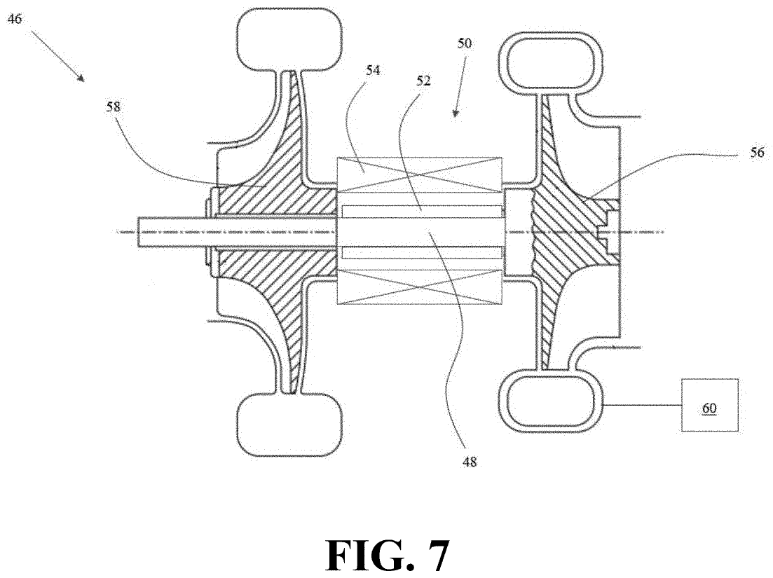

With reference to FIGS. 1-6, the system 30 further includes an electrically-assisted turbomachine 46. The electrically-assisted turbomachine includes a shaft 48 and a second electric machine 50 configured to deliver rotational torque to the shaft 48 and to generate electrical energy from rotation of the shaft 48. As shown in FIG. 7, the second electric machine 50 may include a rotor 52 rotatably coupled to the shaft 48, and a stator 54 disposed about the rotor 52. In one embodiment, the electrically-assisted turbomachine 46 is further defined as an electrically-assisted turbocharger including a turbine wheel 56, a compressor wheel 58, and a wastegate valve 60 for directing a flow of exhaust gas to the turbine wheel 56 to rotate the shaft 48 of the electrically-assisted turbocharger.

With continued reference to FIGS. 1-6, the system 30 additionally includes a hybrid propulsion traction battery 62 electrically coupled to the first and second electric machines 44, 50. The hybrid propulsion traction battery 62 is configured to deliver electrical energy to the first electric machine 44, and to receive electrical energy from the first and second electric machines 44, 50 for charging the hybrid propulsion traction battery 62. The hybrid propulsion traction battery 62 may also be configured to deliver electrical energy to the second electric machine 50 to provide additional boost to the electrically-assisted turbomachine 46. It is to be appreciated that the hybrid vehicle 32 may be referred to as a mild hybrid vehicle or a strong hybrid vehicle. When the hybrid vehicle 32 is a mild hybrid vehicle, the first electric machine 44 and the hybrid propulsion traction battery 62 of the hybrid vehicle are configured to deliver rotational torque to assist the hybrid vehicle with acceleration and to generate electrical energy through regenerative braking. In some instances, when the hybrid vehicle 32 is a mild hybrid vehicle, the first electric machine may be able to drive the hybrid vehicle 32 in an electric motor drive mode where only the first electric machine 44 is delivering rotational torque to drive the hybrid vehicle 32. When the hybrid vehicle 32 is a strong hybrid vehicle, the first electric machine 44 is configured to deliver rotational torque to assist in accelerating the hybrid vehicle 32, and to generate electrical energy through regenerative braking. Under some operating conditions, the first electric machine 44 in a strong hybrid vehicle is able to drive the hybrid vehicle 32 in an electric motor drive mode where only the first electric machine 44 is delivering rotational torque to drive the hybrid vehicle 32.

The system 30 further includes an electronic control unit 64 configured to control electrical energy supplied to the first electric machine 44 from the hybrid propulsion traction battery 62, and to control electrical energy supplied to the hybrid propulsion traction battery 62 from the first and second electric machines 44, 50. As described in further detail below, the electronic control unit 64 typically determines when to supply electrical energy to the first electric machine 44, and when to determine when to supply electrical energy from the first and second electric machines 44, 50 to the hybrid propulsion traction battery 62.

Having the electronic control unit 64 configured to control electrical energy supplied to the first electric machine 44 from the hybrid propulsion traction battery 62 and to control electrical energy supplied to the hybrid propulsion traction battery 62 from the first and second electric machines 44, 50 optimizes when to supply electrical energy from the hybrid propulsion traction battery 62 to the first electric machine 44 and when to control electrical energy supplied to the hybrid propulsion traction battery 62 from the first and second electric machines 44, 50. Additionally, having the electronic control unit 64 configured to control electrical energy supplied to the first electric machine 44 from the hybrid propulsion traction battery 62, and to control electrical energy supplied to the hybrid propulsion traction battery 62 from the first and second electric machines 44, 50 allows the rate of charge of the hybrid propulsion traction battery 62 to increase. Furthermore, having the electronic control unit 64 configured to control electrical energy supplied to the first electric machine 44 from the hybrid propulsion traction battery 62, and to control electrical energy supplied to the hybrid propulsion traction battery 62 from the first and second electric machines 44, 50 allows the hybrid propulsion traction battery 62 to be smaller than conventional hybrid propulsion traction batteries, as the state of charge of the hybrid propulsion traction battery 62 may be replenished quicker than conventional hybrid propulsion traction batteries. In doing so, the hybrid propulsion traction battery 62 takes up less space in the hybrid vehicle 32 and weighs less, which ultimately lowers cost of the hybrid propulsion traction battery 62 and increases fuel economy of the hybrid vehicle 32. Furthermore, having the electronic control unit 64 configured to control electrical energy supplied to the first electric machine 44 from the hybrid propulsion traction battery 62, and to control electrical energy supplied to the hybrid propulsion traction battery 62 from the first and second electric machines 44, 50 allows the electronic control unit 64 to determine which of the first electric machine 44, the second electric machine 50, or the first and second electric machines 44, 50 to charge the hybrid propulsion traction battery 62 is more efficient. Also, having the electronic control unit 64 configured to control electrical energy supplied to the first electric machine 44 from the hybrid propulsion traction battery 62, and to control electrical energy supplied to the hybrid propulsion traction battery 62 from the first and second electric machines 44, 50 allows the hybrid propulsion traction battery 62 to be charged quicker than conventional systems. As a result of the above, the system 30 is able to more readily meet driving demands of the hybrid vehicle 32.

As described in further detail below, various metrics of the hybrid vehicle 32 can be used to determine the most efficient way to drive the hybrid vehicle 32 and to charge the hybrid propulsion traction battery 62 of the hybrid vehicle 32. For example, a brake-specific fuel consumption (BSFC) value of the internal combustion engine 34 and/or an electric brake-specific fuel consumption (eBSFC) value of the first and second electric machines 44, 50 may be used. The BSFC value is defined by the following formula:

$$BSFC = \frac{\dot{m} f + Δ \dot{m} f}{P + Δ Pcrankshaft} ,$$

where mf=the rate of fuel provided to the internal combustion engine 34 that is required to meet a vehicle load demand of the hybrid vehicle 32,
where Δmf=the difference in the rate of fuel provided to the internal combustion engine 34 with and without generating electric power either with the first electric machine 44, the second electric machine 50, or the first and second electric machines 44, 50,
where P=power of the crankshaft 36 of the internal combustion engine 34 required to meet the vehicle load demand of the hybrid vehicle 32, and
where ΔPcrankshaft=the difference in the power of the crankshaft 36 of the internal combustion engine 34 required without driving the first electric machine 44 and with driving the first electric machine 44.

The BSFC value is used by the electronic control unit 64 to determine whether to drive the hybrid vehicle 32 in an electric mode with the first electric machine 44. In other words, whether to drive the hybrid vehicle 32 in an all-electric mode, or whether to use the first electric machine 44 to assist the internal combustion engine 34 in driving the hybrid vehicle 32. To determine which electrical source, i.e., the first and second electric machines 44, 50, to use to charge the hybrid propulsion traction battery 62, the eBSFC value is determined. In other words, the eBSFC value associated with the use of the first and second electric machines 44, 50 is determined. The eBSFC value is defined by the following formula:

$$e B S F C = \frac{Δ \dot{m} f}{Δ P e l e c t r i c}$$

where Δmf=the difference in the rate of fuel provided to the internal combustion engine 34 with and without generating electric power either with the first electric machine 44, the second electric machine 50, or the first and second electric machines 44, 50, and
where ΔPelectric=the electric power generated by the first electric machine 44, the second electric machine 50, or the first and second electric machines 44, 50.

The eBSFC value may then be determined based on whether the first electric machine 44 is used to charge the hybrid propulsion traction battery 62, whether the second electric machine 50 is used to charge the hybrid propulsion traction battery 62, and/or whether the first and second electric machines 44, 50 are used to charge the hybrid propulsion traction battery 62. In other words, the eBSFC value changes based on whether the first and/or second electric machines 44, 50 is used to charge the hybrid propulsion traction battery 62. By way of example, in Case 1 in Table 1 below, the internal combustion engine 34 is provided power for only the hybrid vehicle 32 propulsion load, i.e., the amount of power needed (vehicle load demand) to drive the hybrid vehicle 32 with only the internal combustion engine 34. In Case 2 below, the internal combustion engine 34 is provided power for the hybrid vehicle 32 propulsion load and also to the first electric machine 44 providing 4 kW of power to the hybrid propulsion traction battery 62. In Case 3 below, the internal combustion engine 34 is provided power for the hybrid vehicle 32 propulsion load and from the second electric machine 50 providing 2 kW of electrical power to the hybrid propulsion traction battery 62.

TABLE 1

| | | Case 1 | Case 2 | Case 3 |
|---|---|---|---|---|
| \dot{m}_{f} | g/hr | 5200 | 5200 | 5200 |
| Δ\dot{m}_{f} | g/hr | — | 800 | 200 |
| P_{crankshaft} | kW | 20 | 20 | 20 |
| P_{electric} | kW | — | 4 | 2 |
| ΔP_{crankshaft} | kW | — | 5 | — |
| BSFC | g/kWhr | 260 | 240 | 270 |
| eBSFC | g/kWhr | — | 200 | 100 |

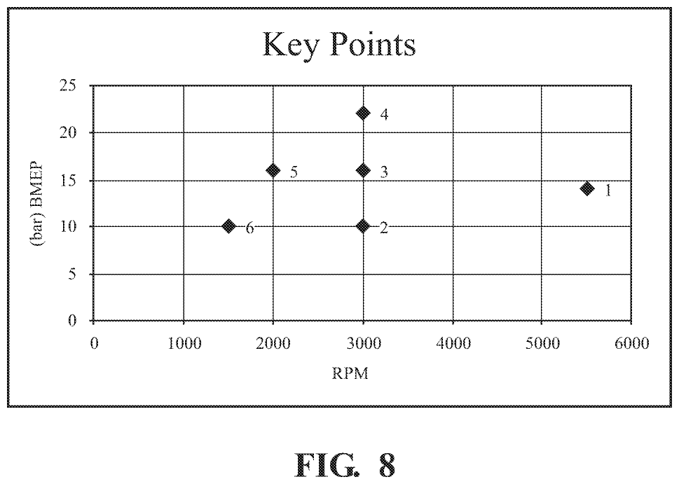

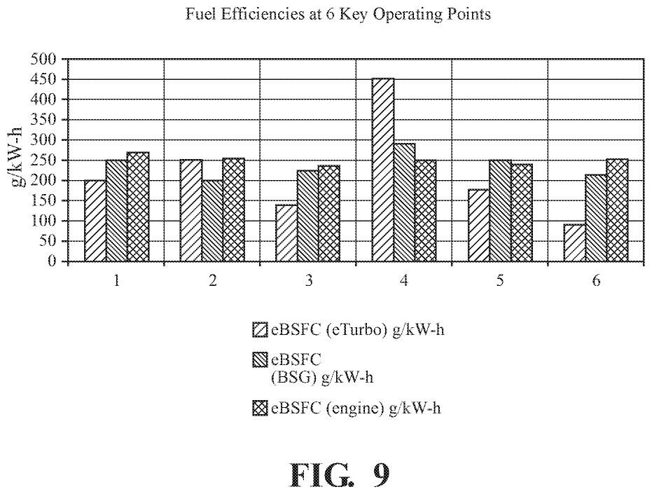

Another example, as shown in FIGS. 8 and 9, six different points of operation of the hybrid vehicle 32 are shown and will be described in further detail below. Specifically, the points 1-6 in FIG. 8 give various operating conditions of the internal combustion engine 34 of the hybrid vehicle 32 based on differing brake mean effective pressure (BMEP) and RPM values of the internal combustion engine 34. As shown in FIG. 9, points 1, 3, 5, and 6 show that using the second electric machine 50 to charge the hybrid propulsion traction battery 62 is more efficient than using the first electric machine 44 to charge the hybrid propulsion traction battery 62 because the eBSFC value associated with the use of the second electric machine 50 is less than the eBSFC value associated with the use of first electric machine 44. In other words, using the second electric machine 50 to charge the hybrid propulsion traction batter 62 is more advantageous than using the first electric machine 44 to charge the hybrid propulsion traction batter 62. At point 2, using the first electric machine 44 to charge the hybrid propulsion traction battery 62 is more efficient than using the second electric machine 50 to charge the hybrid propulsion traction battery 62 because the eBSFC value associated with the use the first electric machine 44 is less than the eBSFC value associated with the use of the second electric machine 50. In other words, using the first electric machine 44 to charge the hybrid propulsion traction battery 62 is more advantageous than using the second electric machine 50 to charge the hybrid propulsion traction battery 62. At point 4, charging the hybrid propulsion traction battery 62 with either of the first and second electric machines 44, 50 is not efficient because the eBSFC associated with the use of the first and second electric machines 44, 50 is greater than threshold eBSFC value, as described in further detail below. In other words, using the first electric machine 44 or using the second electric machine 50 is not advantageous to charge the hybrid propulsion traction battery 62.

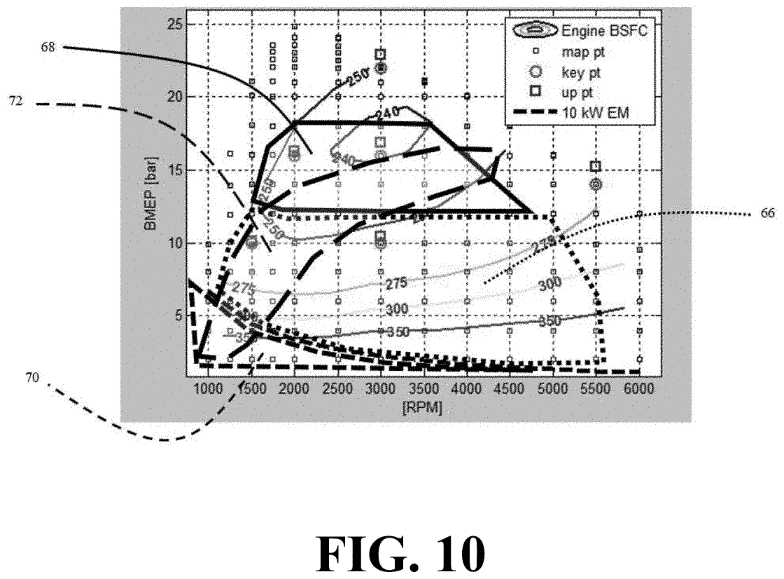

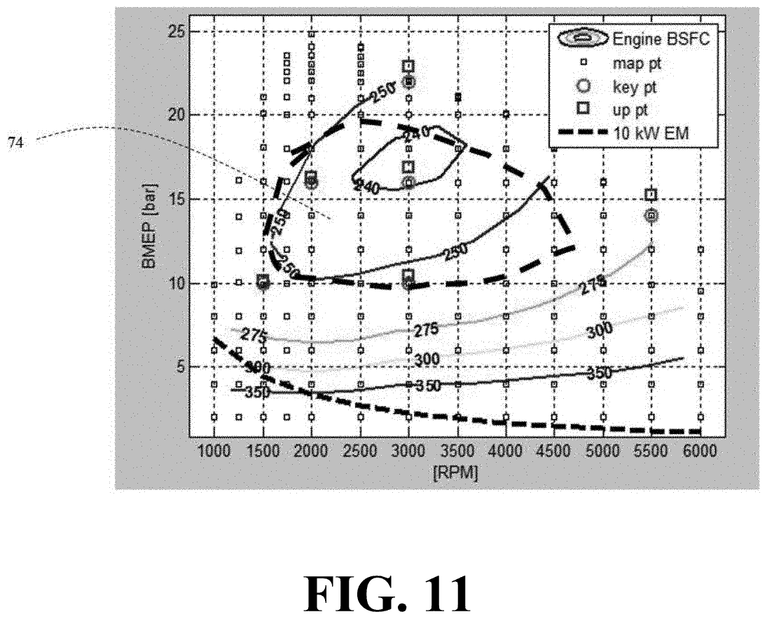

With reference to FIG. 10, various regions of operation of the hybrid vehicle 32 including the first electric machine 44, the second electric machine 50, and the internal combustion engine 34 are shown. By way of example, a first region 66 enclosed by a dotted line in FIG. 10 is illustrative of where it may be advantageous to charge the hybrid propulsion traction battery 62 with the first electric machine 44. In other words, the eBSFC value associated with the use of the first electric machine 44 is lower than the eBSFC value associated with the use of the second electric machine 50 and, therefore, the first electric machine 44 is more efficient to use to charge the hybrid propulsion traction battery 62 than using the second electric machine 50. By way of another example, a second region 68 enclosed by a solid line is illustrative of where it may be advantageous to charge the hybrid propulsion traction battery 62 with the second electric machine 50. In other words, the eBSFC value associated with the use of the second electric machine 50 is lower than the eBSFC value associated with the use of the first electric machine 44 and, therefore, the second electric machine 50 is more efficient to use to charge the hybrid propulsion traction battery 62 than using the first electric machine 44. By way of another example, a third region 70 enclosed by a dashed line is illustrative of where it may be advantageous to drive the hybrid vehicle 32 with the first electric machine 44 without the internal combustion engine 34, i.e., in an all-electric mode. One example, as discussed above, the first electric machine 44 may be a belt alternator starter. By way of another example, a fourth region 72 enclosed by dashed lines represents a typical operating range of the internal combustion engine 34. As shown in FIG. 10, the fourth region 72 overlaps with the first region 66, the second region 68, and the third region 70. With reference to FIG. 11, a fifth region 74 is illustrative of where it may be advantageous to charge the hybrid propulsion traction battery 62 with both the first and second electric machines 44, 50.

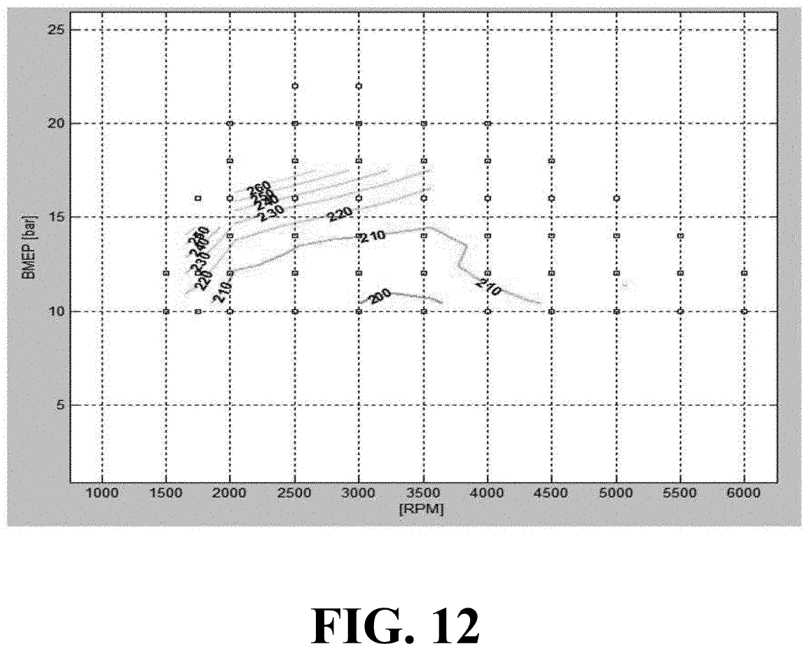

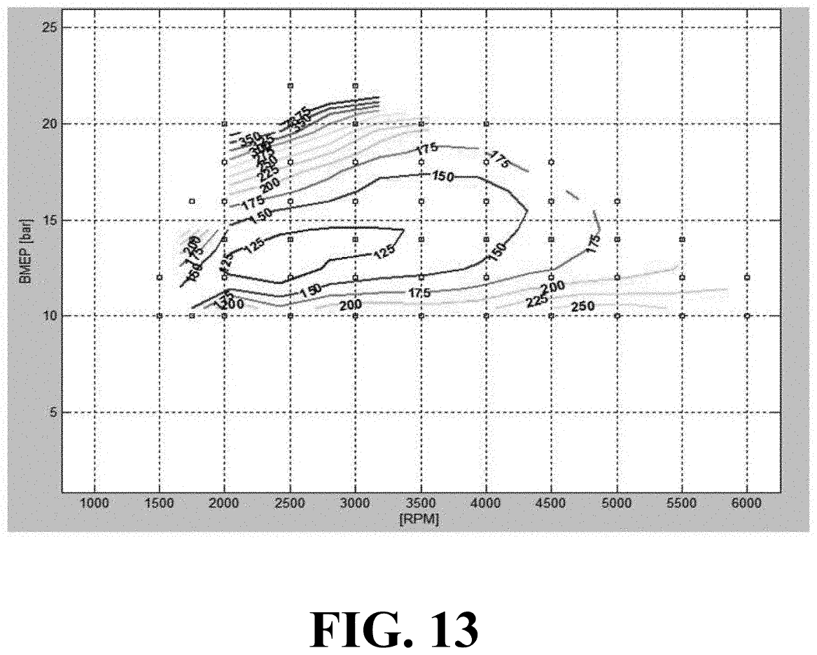

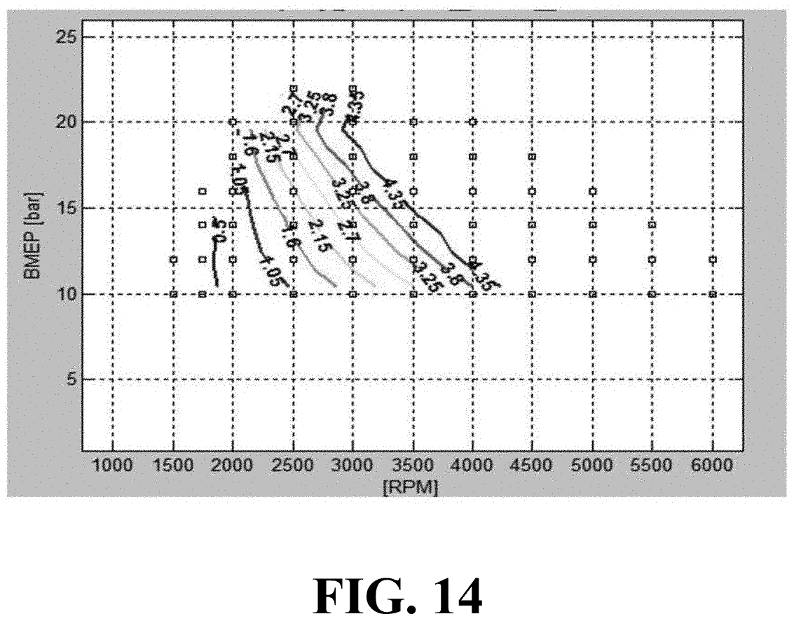

With reference to FIGS. 12 and 13, various eBSFC values are graphically shown. In FIG. 12, eBSFC values associated with the use of the first electric machine 44 are shown based on the BMEP and RPM of the internal combustion engine 34. In particular, the eBSFC values shown in FIG. 12 are a typical representation of when the first electric machine 44 is rotatably coupled to the crankshaft 36 as a P1 hybrid module, as described above. In FIG. 13, eBSFC values associated with the use of the second electric machine 50 are shown based on the BMEP and RPM of the internal combustion engine 34. The eBSFC values in FIGS. 12 and 13 can be averaged together to determine the average eBSFC in the fifth region 74 in FIG. 11. With reference to FIG. 14, values of electrical power generated in kW from the second electric machine 50 is shown based on the BMEP and RPM of the internal combustion engine 34.

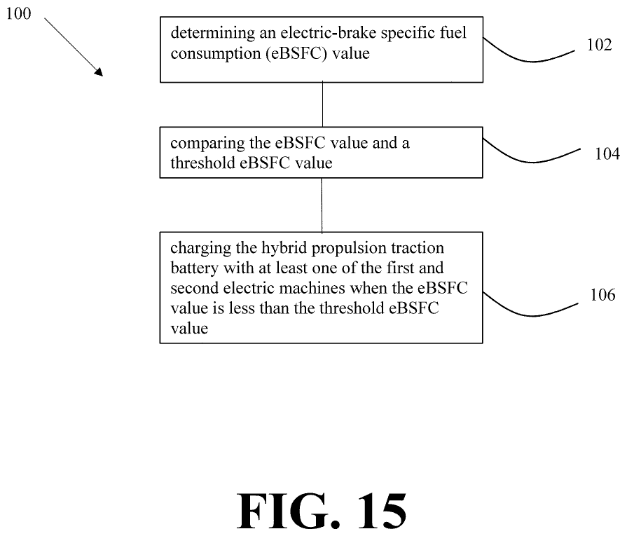

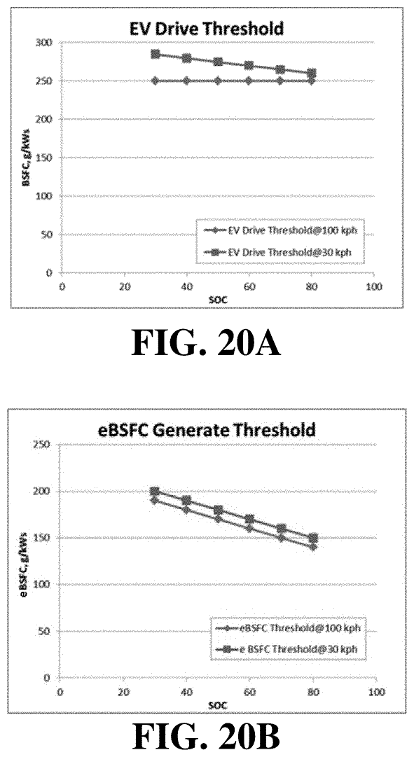

A method 100 for regenerating electrical energy and for using the electrical energy for driving the hybrid vehicle 32 includes the step of determining an electric-brake specific fuel consumption (eBSFC) value, as indicated by block 102 in FIG. 15. The method 100 also includes the step of comparing the eBSFC value and a threshold eBSFC value, as indicated by block 104. The method 100 additionally includes the step of charging the hybrid propulsion traction battery 62 with at least one of the first and second electric machines 44, 50 when the eBSFC value is less than the threshold eBSFC value, as indicated by block 106. The threshold eBSFC value is defined as the value at which it is advantageous to use the first and/or second electric machines 44, 50 to charge the hybrid propulsion traction battery 62 if the eBSFC value associated with the use of the first and/or second electric machines 44, 50 is less than the threshold eBSFC value. An example of threshold eBSFC values are shown in FIG. 20B.

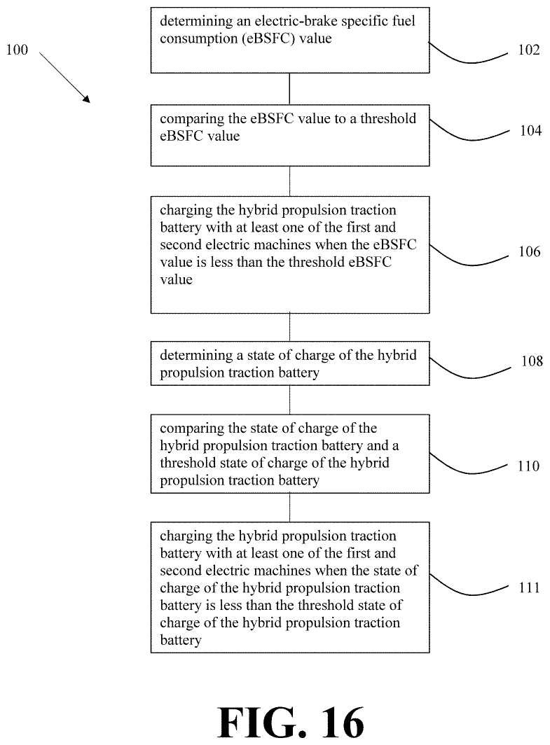

In one embodiment, as shown in FIG. 16, the method 100 includes the steps of determining a state of charge of the hybrid propulsion traction battery 62, as indicated by block 108, comparing the state of charge of the hybrid propulsion traction battery 62 and a threshold state of charge of the hybrid propulsion traction battery 62, as indicated by block 110, and charging the hybrid propulsion traction battery 62 with at least one of the first and second electric machines 44, 50 when the state of charge of the hybrid propulsion traction battery 62 is less than the threshold state of charge of the hybrid propulsion traction battery 62, as indicated by box 111. By way of non-limiting example, the threshold state of charge of the hybrid propulsion traction battery 62 may be between 30% and 80% of the full charge of the hybrid propulsion traction battery 62. The threshold state of charge of the hybrid propulsion traction battery 62 may be 40%, 50%, 60%, or 70% of the full state of charge of the hybrid propulsion traction battery 62. It is to be appreciated that the threshold state of charge of the hybrid propulsion traction battery 62 may be measured in terms of kWhr. For example, if the full charge of the hybrid propulsion traction battery 62 is 14 kWhr and the threshold state of charge of the hybrid propulsion traction battery is 50%, at least one of the first and second electric machines 44, 50 charges the hybrid propulsion traction battery 62 when the charge of the hybrid propulsion traction battery 62 is less than 7 kWhr.

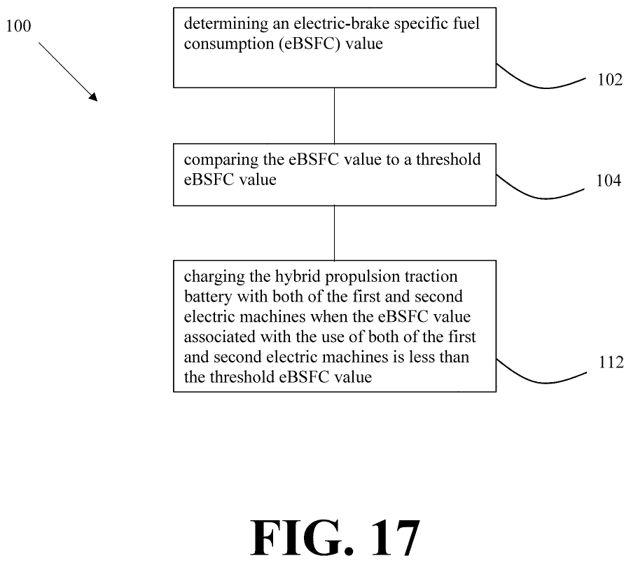

In some embodiments, the step 106 of charging the hybrid propulsion traction battery 62 with at least one of the first and second electric machines 44, 50 when the eBSFC value is less than the threshold eBSFC value is further defined as charging the hybrid propulsion traction battery 62 with both of the first and second electric machines 44, 50 when the eBSFC value associated with the use of both of the first and second electric machines 44, 50 is less than the threshold eBSFC value, as indicated by box 112 shown in FIG. 17. As described above, the fifth region 74 in FIG. 11 is an example of operating conditions that would be advantageous to use both the first and second electric machines 44, 50 to charge the hybrid propulsion traction battery 62. Having the hybrid propulsion traction battery 62 charged by both the first and second electric machines 44, 50 allows the rate of charge of the hybrid propulsion traction battery 62 to increase, i.e., the hybrid propulsion traction battery 62 charges quicker. Additionally, charging the hybrid propulsion traction battery 62 with both of the first and second electric machines 44, 50 allows the hybrid propulsion traction battery 62 be smaller than conventional hybrid propulsion traction batteries. In doing so, the hybrid propulsion traction battery 62 takes up less space in the hybrid vehicle 32 and weighs less, which ultimately lowers cost of the hybrid propulsion traction battery 62 and increases fuel economy of the hybrid vehicle 32. As a result of the above, the system 30 is able to more readily meet driving demands of the hybrid vehicle 32.

When the hybrid propulsion traction battery 62 is charged with both of the first and second electric machines 44, 50, the method 100 may further include the step of determining a brake mean effective pressure (BMEP) of the internal combustion engine 34, and determining a rotations per minute (RPM) of the crankshaft 36 of the internal combustion engine 34. When determining the BMEP and the RPM, the step 112 of charging the hybrid propulsion traction battery 62 with both of the first and second electric machines 44, 50 when the eBSFC value associated with the use of both the first and second electric machines 44, 50 may occur when the BMEP is between 10 bar and 25 bar, and when the RPM is between 1,100 and 6,000, illustrated by way of example in FIG. 11. In other embodiments, the BMEP may be between 10 and 20 bar, 12 and 18 bar, and 14 and 16 bar. The RPM may be between 1,500 and 5,000, 2,000 and 4,500, and 2,500 and 4,000.

In embodiments where the electrically-assisted turbomachine 46 is further defined as the electrically-assisted turbocharger, the step 106 of charging the hybrid propulsion traction battery 62 with at least one of the first and second electric machines 44, 50 when the eBSFC value is less than the threshold eBSFC value is further defined as charging the hybrid propulsion traction battery 62 with only the second electric machine 50 by closing the wastegate valve 60 when the eBSFC value associated with the use of the second electric machine 50 is less than the threshold eBSFC value. Closing the wastegate valve raises a backpressure in the internal combustion engine 34, which results in generating electricity with the second electric machine 50. Alternatively, exhaust flow through the electrically-assisted turbocharger may be facilitated by controlling guide flaps of a variable turbine geometry (VTG) turbocharger. Although not required, the step of charging the hybrid propulsion traction battery 62 with only the second electric machine by closing the wastegate valve 60 when the eBSFC value associated with the use of the second electric machine 50 is less than the threshold eBSFC value is performed when braking regeneration is unavailable, i.e., through the first electric machine 44.

In one embodiment, the step 106 of charging the hybrid propulsion traction battery 62 with at least one of the first and second electric machines 44, 50 when the state of charge of the hybrid propulsion traction battery 62 is less than threshold state of charge of the hybrid propulsion traction battery 62 is further defined as charging the hybrid propulsion traction battery 62 with only the first electric machine 44 when the eBSFC value associated with the use of the second electric machine 50 is less than the threshold eBSFC value. As described above, an example of operating conditions of the hybrid vehicle 32 where only the first electric machine 44 is used to charge the hybrid propulsion traction battery 62 is illustrated in FIG. 10 as the first region 66.

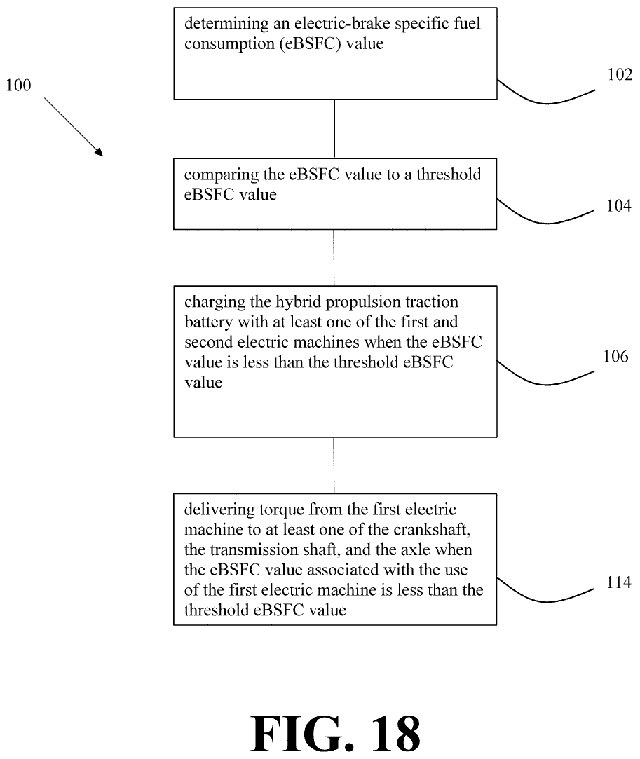

The method 100 may include the step of delivering torque from the first electric machine to at least one of the crankshaft 36, the transmission shaft 40, and the axle 42 when the eBSFC value associated with the use of the first electric machine 44 is less than the threshold eBSFC value, as indicated by box 114 in FIG. 18. Furthermore, when the method 100 includes the step of delivering torque from the first electric machine 44 to at least one of the crankshaft 36, the step 114 of delivering torque from the first electric machine 44 to the crankshaft 36 when the eBSFC value associated with the use of the second electric machine 50 is less than the threshold eBSFC value may be further defined as delivering torque only from the first electric machine 44 to the crankshaft 36 when the eBSFC value associated with the use of the second electric machine 50 is less than the threshold eBSFC value. As described above, an example of operating conditions of the hybrid vehicle 32 where only the first electric machine 44 is used to drive the hybrid vehicle 32 is illustrated in FIG. 10 as the third region 70.

Additionally, when the method 100 includes the step of delivering torque from the first electric machine 44 to at least one of the crankshaft 36, the transmission shaft 40, and the axle 42 when the eBSFC value associated with the use of the second electric machine 50 is less than the threshold eBSFC value, the method 100 may also include the step delivering torque from the internal combustion engine 34 to the crankshaft 36. In such embodiments, both the internal combustion engine 34 and the first electric machine 44 are delivering rotational torque to drive the hybrid vehicle 32.

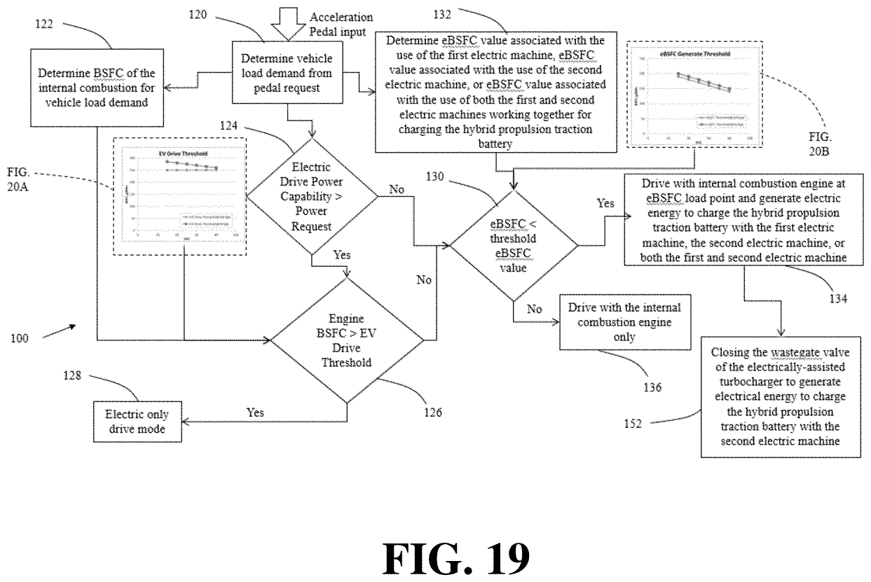

With reference to FIG. 19, a flow chart of one embodiment of the method 100 is shown. As indicated by box 120, the method 100 may include the step of determining a vehicle load demand input request based on movement of an acceleration pedal. After the input request from the acceleration pedal, the method 100 may include the step of determining the BSFC of the internal combustion engine 34, as indicated by box 122. The method 100 may also include the step of determining whether the electric drive power capability of the first electric machine 44 is greater than the input vehicle load demand request, as indicated by box 124. If the electric drive power capability of the first electric machine 44 is greater than the input vehicle load demand request and the electric vehicle drive threshold is exceeded, for example as shown in FIG. 20A, then the method 100 may include the step of determining if the BSFC of the internal combustion engine 34 is greater than the electric vehicle drive threshold, as indicated by box 126. If box 126 is yes, then the method 100 may include the step of driving the hybrid vehicle 32 in an electric-only drive mode, as indicated by box 128. If boxes 126 and 124 are no, then the method 100 may include the step of determining if the eBSFC value associated with the use of the first electric machine 44 and/or the second electric machine 50 is less than the threshold eBSFC value, as indicated by box 130. Typically, if the eBSFC value associated with the use of the first electric machine 44 or the second electric machine 50 is less than the eBSFC threshold, then first electric machine 44 and/or the second electric machine 50 is used to generate electrical energy to charge the hybrid propulsion traction battery 62. An example of the eBSFC generate threshold is shown in FIG. 20B. In FIG. 20B, an example of the eBSFC threshold value is shown at 100 kph and 30 kph. If the eBSFC value is less than the threshold eBSFC values shown in FIG. 20B, then the first and/or second electric machines 44, 50 may be used to generate electrical energy to charge the hybrid propulsion traction battery 62. As indicated by box 132, the method 100 may include the step of determining the eBSFC value associated with the use of the first electric machine 44, the eBSFC value associated with the use of the second electric machine 50, or the eBSFC value associated with the use of both the first and second electric machines 44, 55 working together for charging the hybrid propulsion traction battery 62. If box 130 is yes, then the method 100 may include the step of driving the internal combustion engine 34 at the eBSFC load point and generate electric energy, as indicated by box 134. In particular, electrical energy is generated from the first electric machine 44, the second electric machine 50, or both the first and second electric machines 44, 50 and is sent to the hybrid propulsion traction battery 62 as the internal combustion engine 34 is used to drive the hybrid vehicle 32. If the second electric machine 50 is used to charge the hybrid propulsion traction battery 62, then the method 100 typically includes the step of closing the wastegate valve 60 of the electrically-assisted turbocharger to generate electrical energy to charge the hybrid propulsion traction battery 62. It is to be appreciated that the lower of the eBSFC values associated with the use of the first and second electric machines 44, 50 may be used to charge the hybrid propulsion traction battery 62, for example, if only one of the first and second electric machines 44, 50 is used to charge the hybrid propulsion traction battery 62. If box 130 is no, then the method 100 may include the step of driving the hybrid vehicle 32 with only the internal combustion engine 34, as indicated by box 136.

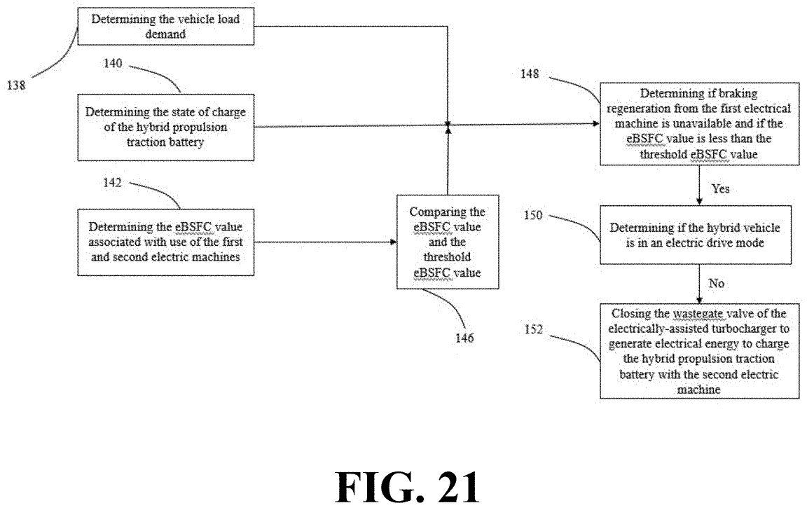

With reference to FIG. 21, a flow chart of one embodiment of the method 100 is shown. In particular, FIG. 21 is an embodiment of the method 100 in which the second electric machine 50 is further defined as the electrically-assisted turbocharger including the wastegate valve 60. The method 100 may include the steps of determining the vehicle load demand of the hybrid vehicle 32, as indicated by box 138; determining the state of charge of the hybrid propulsion traction battery 62, as indicated by box 140; determining the eBSFC value associated with the use of the first and second electric machines 44, 50, as indicated by box 142; and comparing the eBSFC value and the threshold eBSFC value, as indicated by box 146. The method 100 illustrated in FIG. 21 may include the step of determining if braking regeneration from the first electric machine 44 is unavailable and if the eBSFC value is less than the threshold eBSFC value, as indicated by box 148. If box 148 is yes, the method 100 may include the step of determining if the hybrid vehicle 32 is in an electric-only drive mode, as indicated by box 150. The electric drive mode includes both an electric-only drive mode, in which the internal combustion engine 34 is turned off, and an electrically-assisted drive mode, in which the internal combustion engine 34 is used to drive the hybrid vehicle 32. If no, the method 100 may include the step of closing the wastegate valve of the electrically-assisted turbocharger to generate electrical energy to charge the hybrid propulsion traction battery 62 with the second electric machine 50, as indicated by box 152.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A method for regenerating electrical energy and for using the electrical energy for driving a hybrid vehicle, with the hybrid vehicle including,
an internal combustion engine including a crankshaft,
a transmission comprising a transmission shaft rotatably coupled to the crankshaft,
an axle rotatably coupled to the transmission shaft,
a first electric machine rotatably coupled at least one of the crankshaft, the transmission shaft, and the axle, with the first electric machine configured to deliver rotational torque to at least one of the crankshaft, the transmission shaft, and the axle, and to generate electrical energy from rotation of at least one of the crankshaft, the transmission shaft, and the axle,
an electrically-assisted turbomachine including a shaft and a second electric machine configured to deliver rotational torque to the shaft, and to generate electrical energy from rotation of the shaft,
a hybrid propulsion traction battery electrically coupled to the first and second electric machines, with the hybrid propulsion traction battery configured to deliver electrical energy to the first electric machine, and to receive electrical energy from the first and second electric machines for charging the hybrid propulsion traction battery, and
an electronic control unit configured to control electrical energy supplied to the first electric machine from the hybrid propulsion traction battery, and to control electrical energy supplied to the hybrid propulsion traction battery from the first and second electric machines,
said method comprising the steps of:
determining an electric-brake specific fuel consumption (eBSFC);
comparing the eBSFC value and a threshold eBSFC value;
charging the hybrid propulsion traction battery with at least one of the first and second electric machines when the eBSFC value is less than the threshold eBSFC value.

2. The method as set forth in claim 1, further comprising the steps of:
determining a state of charge of the hybrid propulsion traction battery;
comparing the state of charge of the hybrid propulsion traction battery and a threshold state of charge of the hybrid propulsion traction battery; and
charging the hybrid propulsion traction battery with at least one of the first and second electric machines when the state of charge of the hybrid propulsion traction battery is less than the threshold state of charge of the hybrid propulsion traction battery.

3. The method as set forth in claim 2, wherein the threshold state of charge is between 30% and 80% of the state of charge of the hybrid propulsion traction battery.

4. The method as set forth in claim 1, wherein the step of charging the hybrid propulsion traction battery with at least one of the first and second electric machines when the eBSFC value is less than the threshold eBSFC value is further defined as charging the hybrid propulsion traction battery with both of the first and second electric machines when the eBSFC value associated with the use of both of the first and second electric machines is less than the threshold eBSFC value.

5. The method as set forth in claim 4, further comprising the steps of:
determining a brake mean effective pressure (BMEP) of the internal combustion engine;
determining a rotations per minute (RPM) of the crankshaft of the internal combustion engine; and
wherein the step of charging the hybrid propulsion traction battery with both of the first and second electric machines when the eBSFC value associated with the use of both the first and second electric machines is less than the threshold eBSFC value occurs when the BMEP is between 10 bar and 25 bar, and when the RPM is between 1,100 and 6,000.

6. The method as set forth in claim 1, wherein the electrically-assisted turbomachine is further defined as an electrically-assisted turbocharger including a turbine wheel, a compressor wheel, and a wastegate valve for directing a flow of exhaust gas to the turbine wheel to rotate the shaft of the electrically-assisted turbocharger, and
wherein the step of charging the hybrid propulsion traction battery with at least one of the first and second electric machines when the eBSFC value is less than the threshold eBSFC value is further defined as charging the hybrid propulsion traction battery with only the second electric machine by closing the wastegate valve when the eBSFC value associated with the use of the second electric machine is less than the threshold eBSFC value.

7. The method as set forth in claim 6, wherein the step of charging the hybrid propulsion traction battery with only the second electric machine by closing the wastegate valve when the eBSFC value associated with the use of the second electric machine is less than the threshold eBSFC value is performed when braking regeneration is unavailable.

8. The method as set forth in claim 1, wherein the step of charging the hybrid propulsion traction battery with at least one of the first and second electric machines when the eBSFC value is less than the threshold eBSFC value is further defined as charging the hybrid propulsion traction battery with only the first electric machine when the eBSFC value associated with the use of the first electric machine is less than the threshold eBSFC value.

9. The method as set forth in claim 1, further comprising the step of delivering torque from the first electric machine to at least one of the crankshaft, the transmission shaft, and the axle when the eBSFC value associated with use of the first electric machine is less than the threshold eBSFC value.

10. The method as set forth in claim 9, wherein the step of delivering torque from the first electric machine to the crankshaft when the state of charge of the hybrid propulsion traction battery is greater than the threshold state of charge of the hybrid propulsion traction battery is further defined as delivering torque only from the first electric machine to the crankshaft when the state of charge of the hybrid propulsion traction battery is greater than the threshold state of charge of the hybrid propulsion traction battery.

11. The method as set forth in claim 9, further comprising the step of delivering torque from the internal combustion engine to the crankshaft.

12. The method as set forth in claim 1, wherein the hybrid vehicle is further defined as a mild hybrid vehicle.

13. The method as set forth in claim 1, wherein the hybrid vehicle is further defined as a strong hybrid vehicle.

14. A system for regenerating electrical energy and for using the electrical energy for driving a hybrid vehicle, said system comprising:
an internal combustion engine comprising a crankshaft;
a transmission comprising a transmission shaft rotatably coupled to said crankshaft;
an axle rotatably coupled to said transmission shaft;
a first electric machine rotatably coupled at least one of said crankshaft, said transmission shaft, and said axle, with said first electric machine configured to deliver rotational torque to at least one of said crankshaft, said transmission shaft, and said axle, and to generate electrical energy from rotation of at least one of said crankshaft, said transmission shaft, and said axle;
an electrically-assisted turbomachine including a shaft and a second electric machine configured to deliver rotational torque to said shaft, and to generate electrical energy from rotation of said shaft;
a hybrid propulsion traction battery electrically coupled to said first and second electric machines, with said hybrid propulsion traction battery configured to deliver electrical energy to said first electric machine, and to receive electrical energy from said first and second electric machines for charging said hybrid propulsion traction battery; and
an electronic control unit configured to control electrical energy supplied to said first electric machine from said hybrid propulsion traction battery, and to control electrical energy supplied to said hybrid propulsion traction battery from said first and second electric machines.

15. The system as set forth in claim 14, wherein said first electric machine is rotatably coupled to said crankshaft such that said first electric machine is configured to deliver rotational torque to said crankshaft and to generate electrical energy from rotation of said crankshaft.

16. The system as set forth in claim 15, wherein said first electric machine is directly rotatably coupled to said crankshaft.

17. The system as set forth in claim 14, wherein said wherein said first electric machine is rotatably coupled to said transmission shaft such that said first electric machine is configured to deliver rotational torque to said transmission shaft and to generate electrical energy from rotation of said transmission shaft.

18. The system as set forth in claim 17, further comprising a disconnect clutch selectively rotatably coupling said crankshaft and said transmission shaft, wherein said first electric machine is directly rotatably coupled to said transmission shaft.

19. The system as set forth in claim 14, wherein said first electric machine is rotatably coupled to said axle such that said first electric machine is configured to deliver rotational torque to said axle and to generate electrical energy from rotation of said axle.

20. The system as set forth in claim 14, wherein the electrically-assisted turbomachine is further defined as an electrically-assisted turbocharger including a turbine wheel, a compressor wheel, and a wastegate valve for directing a flow of exhaust gas to the turbine wheel to rotate the shaft of the electrically-assisted turbocharger.
